(19) United States
(12) Patent Application Publication
(10) Pub. No.: US 2020/0295449 A1
(43) Pub. Date: Sep. 17, 2020

(54) ANTENNA DEVICE

(71) Applicant: Panasonic Intellectual Property Management Co., Ltd., Osaka (JP)

(72) Inventor: Taichi HAMABE, Kanagawa (JP)

(21) Appl. No.: 16/885,988

(22) Filed: May 28, 2020

Related U.S. Application Data
(63) Continuation of application No. PCT/JP2018/043676, filed on Nov. 28, 2018.

(30) Foreign Application Priority Data
Nov. 30, 2017 (JP) 2017-231213

(51) Int. Cl. H01Q 1/38; H01Q 1/48; H01Q 1/24; H01Q 5/378; H01Q 9/04

(52) U.S. Cl. CPC H01Q 1/38; H01Q 1/48; H01Q 9/045; H01Q 5/378; H01Q 1/24

(57) ABSTRACT

An antenna device of the present disclosure includes a substrate having an artificial magnetic conductor, a plurality of antenna conductors disposed on the substrate, and a parasitic conductor disposed on the substrate. The parasitic conductor is apart from and adjacent to the plurality of antenna conductors.

### TECHNICAL FIELD

The present disclosure relates to an antenna device.

### BACKGROUND ART

PTL 1 discloses an antenna device using an artificial magnetic conductor (hereinafter, referred to as AMC).

### CITATION LIST

### Patent Literature

PTL1: Unexamined Japanese Patent Publication No. 2015-70542

### SUMMARY

The present disclosure provides an antenna device that can be miniaturized while a frequency characteristic of the antenna device at a fundamental wave is maintained.

An antenna device of the present disclosure includes: a substrate having an artificial magnetic conductor; a plurality of antenna conductors disposed on the substrate; and a parasitic conductor disposed on the substrate. The parasitic conductor is apart from and adjacent to the plurality of antenna conductors.

According to the present disclosure, the antenna conductor and a parasitic conductor are disposed to be opposed to an artificial magnetic conductor, so that capacitive coupling between the antenna conductor and the artificial magnetic conductor is enhanced to increase a capacitance, and thus a receivable frequency can be shifted to a low frequency band side. Further, the antenna device can work appropriately at frequencies on the lower frequency band side without increasing the length of the antenna conductor, so that the antenna device can be miniaturized.

### BRIEF DESCRIPTION OF DRAWINGS

FIG. 1 is a perspective view showing an outer appearance of antenna device 100 according to a first exemplary embodiment.

FIG. 2 is a vertical cross sectional view along line II-II of FIG. 1.

FIG. 3 is an upper surface view of antenna device 100 of FIG. 1, where layers upper than AMC 20 are deleted.

FIG. 4 is an upper surface view of antenna device 100 of FIG. 1, where layers upper than ground conductor 30 are deleted.

FIG. 5 is a graph showing frequency characteristics of voltage standing wave ratios of antenna device 100 of FIG. 1, where two cases are compared: one has parasitic conductor 6, and the other has no parasitic conductor 6.

FIG. 6 is a perspective view showing an outer appearance of antenna device 200 according to a second exemplary embodiment.

FIG. 7A is an upper surface view of antenna device 300 according to a third exemplary embodiment, where layers upper than AMC 20 are deleted.

FIG. 7B is a graph showing a frequency at which a voltage standing wave ratio exhibits a minimum with respect to a ratio L1/L2, which is a ratio of a length L1 of an antenna conductor to a length L2 of a parasitic conductor of antenna device 300.

FIG. 7C is a graph showing a fractional bandwidth with respect to a ratio L1/L2, which is a ratio of the length L1 of the antenna conductor to the length L2 of the parasitic conductor of antenna device 300.

FIG. 8 is a diagram showing a configuration of AMC 26 of antenna device 101 according to a first modified example.

FIG. 9 is a diagram showing a configuration of AMC 27 of antenna device 102 according to a second modified example.

FIG. 10 is a diagram showing a configuration of AMC 28 of antenna device 103 according to a third modified example.

FIG. 11 is a diagram showing a configuration of AMC 29 of antenna device 104 according to a fourth modified example.

### DESCRIPTION OF EMBODIMENTS

In the following, with reference to the drawings appropriately, a detailed description will be given on exemplary embodiments specifically showing antenna devices according to the present disclosure (hereinafter, the exemplary embodiments are referred to as the present exemplary embodiments). However, an unnecessarily detailed description will be omitted in some cases. For example, a detailed description of a well-known matter and a duplicated description of substantially the same configuration will be omitted in some cases. This is to avoid the following description from being unnecessarily redundant and thus to help those skilled in the art to easily understand the description. Note that the accompanying drawings and the following description are provided to help those skilled in the art to sufficiently understand the present disclosure, and are not intended to limit the subject matter of the claims.

In the following, the present exemplary embodiments preferable to practice the present disclosure will be described in detail with reference to the drawings.

Note that, in the following exemplary embodiments, modified example, and comparative example, a description will be given below, taking as an example an antenna device that is for a 2.4 GHz band (for example, 2,400 MHz to 2,500 MHz) and is for Bluetooth (registered trademark), for Wi-Fi, or for various types of electronic equipment. However, an antenna device of the present disclosure can be used also in other frequency bands.

### First Exemplary Embodiment

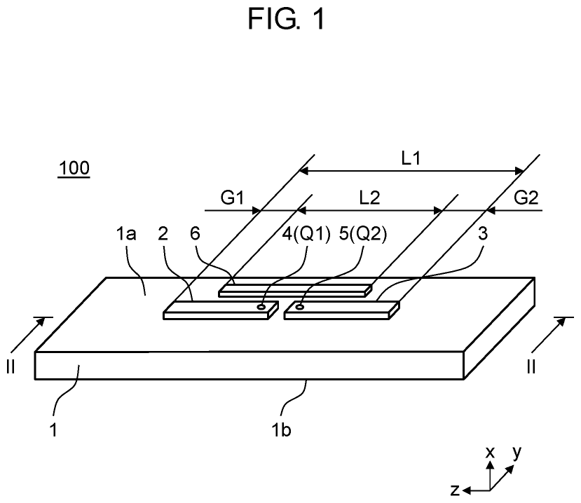

In the following, with reference to FIGS. 1 to 4, a configuration of antenna device 100 according to a first exemplary embodiment will be described.

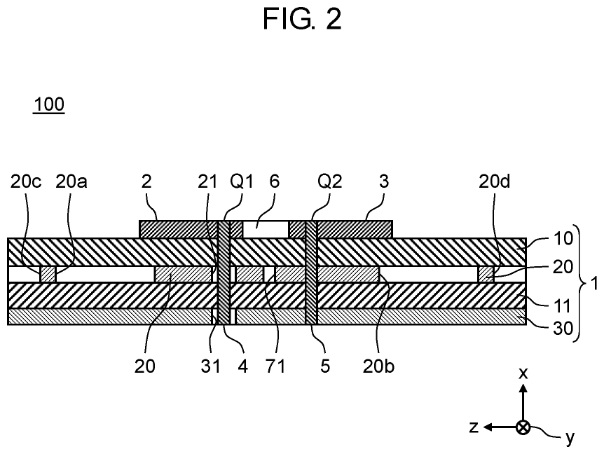

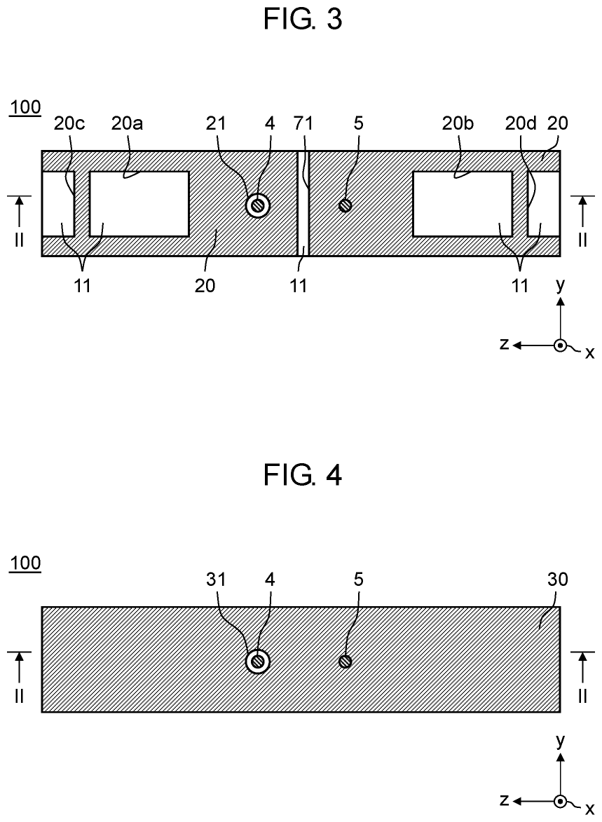

FIG. 1 is a perspective view showing an outer appearance of antenna device 100 according to the first exemplary embodiment, and FIG. 2 is a vertical cross sectional view along line II-II of FIG. 1. Further, FIG. 3 is an upper surface view of antenna device 100 of FIG. 1, where layers upper than AMC 20 are deleted (+x direction correspond the upper side), and FIG. 4 is an upper surface view of antenna device 100 of FIG. 1, where layers upper than ground conductor 30 are deleted. Antenna device 100 of the present exemplary embodiment can be attached to a display device like a television device.

In the following exemplary embodiments, comparative example, and modified examples, description will be given, taking a dipole antenna as an example of antenna device 100. The dipole antenna is formed on a printed wiring board 1 (hereinafter, referred to as substrate 1 in some cases) that is a laminated substrate having a plurality of layers, and a pattern of the dipole antenna is formed by performing etching or other processing on a metal foil on the surface. Each of the plurality of layers is configured with a copper foil or glass epoxy.

As shown in FIGS. 1 and 2, antenna device 100 includes: printed wiring board 1; antenna conductor 2 that is a strip conductor and is an example of a feeding antenna; antenna conductor 3 that is a strip conductor and is an example of a parasitic antenna (grounded antenna); via conductor 4; via conductor 5; and parasitic conductor 6 disposed on a side of antenna conductors 2, 3 (on a +y direction side). Via conductor 4 constitutes a feeding conductor of a power feed line between feeding point Q1 of antenna conductor 2 and a wireless communication circuit (not shown in the drawing but is assembled on rear surface 1b of printed wiring board 1). Via conductor 5 constitutes a ground conductor of a power feed line between feeding point Q2 of antenna conductor 3 and the wireless communication circuit. Parasitic conductor 6 is a parasitic pattern electrically separated from antenna conductors 2, 3.

Antenna conductor 2 and antenna conductor 3 constitute, for example, a dipole antenna, and longitudinal directions of antenna conductors 2, 3 respectively extend in a straight line in a +z direction and a −z direction. In addition, ends of antenna conductors 2, 3 on the side of feeding points Q1, Q2 (hereinafter, referred to as feeding-side ends) are formed on surface 1a of printed wiring board 1 so as to be a predetermined space apart from each other. Note that both ends, of antenna conductors 2, 3, on the opposite sides of the feeding-side ends (the both ends are maximally apart from each other in the whole of antenna device 100) are hereinafter referred to as tip-side ends of antenna conductors 2, 3. Further, a distance between the tip-side end of antenna conductor 2 and the tip-side end of antenna conductor 3 in the z direction is defined as a length L1 of the antenna conductor.

Via conductors 4, 5 are each formed by filling through-holes formed through in a thickness direction from surface 1a to rear surface 1b of printed wiring board 1 with conductor. Since antenna conductor 2 functions as a feeding antenna, antenna conductor 2 is connected to a feeding terminal of the wireless communication circuit on rear surface 1b of printed wiring board 1 via conductor 4. Further, since antenna conductor 3 functions as a parasitic antenna, antenna conductor 3 is connected to ground conductor 30 in printed wiring board 1 and to the ground terminal of the wireless communication circuit via conductor 5.

In this description, the z direction means the longitudinal directions of antenna device 100 and antenna conductors 2, 3 of antenna device 100. The y direction means width directions of antenna device 100 and antenna conductors 2, 3 of antenna device 100, and is perpendicular to the z direction. The x direction means a thickness direction of antenna device 100 and perpendicular to the yz plane. In printed wiring board 1, via conductors 4, 5 are respectively formed at positions substantially directly under feeding points Q1, Q2. Note that printed wiring board 1 of antenna device 100 may be assembled, for example, on a printed wiring board of electronic equipment.

With reference to FIG. 2, printed wiring board 1, which is a laminated substrate, is configured with dielectric substrate 10, AMC 20, dielectric substrate 11, and ground conductor 30 in this order. In FIG. 2, dielectric substrate 10, dielectric substrate 11, and ground conductor 30 each has substantially the same shape but each may have different shapes. For example, if ground conductor 30 larger than dielectric substrate 10 and dielectric substrate 11 is used, ground conductor 30 can be shared with other antennas. Dielectric substrates 10, 11 are formed of, for example, glass epoxy or other materials. AMC 20 is an artificial magnetic conductor having perfect magnetic conductor (PMC) characteristics and is formed of a predetermined metal pattern. By using AMC 20, an antenna can be made thinner and can have a higher gain. Printed wiring board 1 is an example of a substrate.

Parasitic conductor 6 is disposed on printed wiring board 1 to be opposed to AMC 20 and to be adjacent to antenna conductors 2, 3 in the width direction with a predetermined distance secured between parasitic conductor 6 and antenna conductors 2, 3. The predetermined distance is, for example, more than or equal to a quarter of a wavelength of a reception radio wave. In the first exemplary embodiment, parasitic conductor 6 is disposed on one of side surfaces of antenna conductors 2, 3 and is in parallel to the z direction in which antenna conductors 2, 3 are disposed. Since, in the same manner as antenna conductors 2, 3, parasitic conductor 6 is opposed to and capacitively coupled to AMC 20 via dielectric substrate 10, a capacitance between antenna conductors 2, 3 and AMC 20 can be increased so that a frequency can be shifted to a lower side.

In the present exemplary embodiment, as shown in FIG. 1, a length L2 of parasitic conductor 6 in the z direction is shorter than the length L1 of the antenna conductors. Further, as shown in FIG. 1, a distance in the z direction between the tip-side end of antenna conductor 2 and an end of parasitic conductor 6 on the antenna conductor 2 side is a gap G1, and a distance in the z direction between the tip-side end of antenna conductor 3 and an end of parasitic conductor 6 on the antenna conductor 3 side is a gap G2. In the present exemplary embodiment, antenna conductors 2, 3 are formed to be plane-symmetric with respect to the xy plane, and parasitic conductor 6 is also formed to be plane-symmetric with respect to the xy plane. Therefore, the gap G1 and the gap G2 are substantially equal to each other.

A size, shape, number, and the like of parasitic conductor 6 are not particularly limited, and parasitic conductor 6 only has to be on the same side as antenna conductors 2, 3 with respect to AMC 20 and to be capacitively coupled to AMC 20, however, parasitic conductor 6 does not have to be disposed to be opposed to AMC 20 via dielectric substrate 10.

Via conductor 4 has a columnar shape and is a power feed line to supply electric power to drive antenna conductor 2 as an antenna, and via conductor 4 electrically connects antenna conductor 2 formed on surface 1a of printed wiring board 1 to the feeding terminal of the above-described wireless communication circuit. Further, to prevent via conductor 4 from being electrically connected to AMC 20 or ground conductor 30, via conductor 4 is formed substantially coaxial to via conductor insulating holes 21, 31 formed in AMC 20 and ground conductor 30. A diameter of via conductor 4 is smaller than diameters of via conductor insulating holes 21, 31.

On the other hand, via conductor 5 is to electrically connect antenna conductor 3 to the ground terminal of the above-described wireless communication circuit, and via conductor 5 is electrically connected to ground conductor 30 and AMC 20.

AMC 20 of FIGS. 2 and 3 is provided with:

(1) opening 20a that has a rectangular shape and is formed to extend in the z direction in a longitudinal direction of antenna conductor 2 from the vicinity of a position that is directly under and substantially opposed to the tip-side end of antenna conductor 2 (opening 20a penetrates through the layer of AMC 20 of FIG. 2 in a thickness direction of AMC 20 within the layer of AMC 20, but is not formed in the vertical direction (+x direction or −x direction) outside the layer of AMC 20);

(2) opening 20c that has a rectangular shape and is formed to extend in the z direction in the longitudinal direction to a left-side end of printed wiring board 1 from a position a predetermined distance apart from opening 20a in the z direction (opening 20c penetrates through the layer of AMC 20 of FIG. 2 in the thickness direction of AMC 20 within the layer of AMC 20, but is not formed in the vertical direction (+x direction or −x direction) outside the layer of AMC 20);

(3) opening 20b that has a rectangular shape and is formed to extend in the −z direction in the longitudinal direction from the vicinity of a position that is directly under and substantially opposed to the tip-side end of antenna conductor 3 (opening 20b penetrates through the layer of AMC 20 of FIG. 2 in the thickness direction of AMC 20 within the layer of AMC 20, but is not formed in the vertical direction (+x direction or −x direction) outside the layer of AMC 20);

(4) opening 20d that has a rectangular shape and is formed to extend in the −z direction in the longitudinal direction to a right-side end of printed wiring board 1 from a position a predetermined distance apart from opening 20b in the −z direction (opening 20d penetrates through the layer of AMC 20 of FIG. 2 in the thickness direction of AMC 20 within the layer of AMC 20, but is not formed in the vertical direction (+x direction or −x direction) outside the layer of AMC 20); and

(5) slit 71 that is formed at a central part in the z direction, penetrates through AMC 20 in the thickness direction of AMC 20, and extends to ends in a width direction of AMC 20.

Each of openings 20a to 20d and slit 71 (including openings according to the exemplary embodiments and modified examples to be described later) includes, for example, so-called slit, slot, through-hole, notch section, and the like, and is a part where no artificial magnetic conductor is formed in the layer of AMC 20. AMC 20 is divided into two parts in the longitudinal direction by slit 71 (the parts of AMC are each referred to as “AMC part” in some cases). Note that, such a configuration that AMC is divided in the longitudinal direction by slit 71 is similarly employed also in the second and third exemplary embodiments, modified examples, and comparative example to be described below.

A position where opening 20a is formed includes a position that is directly under and is substantially opposed to the tip-side end of antenna conductor 2 (the position corresponds to a central part of a left half part of AMC 20 (that is, printed wiring board 1)) and that extends in the z direction toward a left-side tip of printed wiring board 1. Further, a position where opening 20b is formed includes a position that is directly under and is substantially opposed to the tip-side end of antenna conductor 3 (the position corresponds to a central part of a right half part of AMC 20 (that is, printed wiring board 1)) and that extends in the −z direction toward a right-side tip of printed wiring board 1.

Openings 20c, 20d respectively extends, for example, in the longitudinal directions of antenna conductors 2, 3 toward tip parts of antenna device 100 from positions that are apart in the longitudinal directions of antenna conductors 2, 3 from positions substantially opposed to the tip-side ends of antenna conductors 2, 3, which tip-side ends are opposite to ends on the side of the feeding points of antenna conductors 2, 3, toward the tip parts of antenna device 100 (in other words, one of openings 20c, 20d is direct under the tip ends of antenna conductors 2, 3). This arrangement is employed also in other exemplary embodiments.

In ground conductor 30 of FIG. 4, there are formed two holes: one is via conductor insulating hole 31 through which via conductor 4 penetrates and which is electrically insulated from ground conductor 30, and the other is a hole through which via conductor 5 penetrates and which is electrically connected to ground conductor 30.

In antenna device 100 according to the first exemplary embodiment, as apparent from FIGS. 2 to 4, AMC 20 and ground conductor 30 have substantially the same rectangular planar shape and has substantially a congruent shape, and AMC 20 and ground conductor 30 are formed to be opposed to each other and to be a predetermined distance apart from each other in the thickness direction. Note that AMC 20 is formed to have openings 20a to 20d and slit 71 but is formed such that a length of AMC 20 in the longitudinal direction is substantially the same as a length of ground conductor 30 in the longitudinal direction.

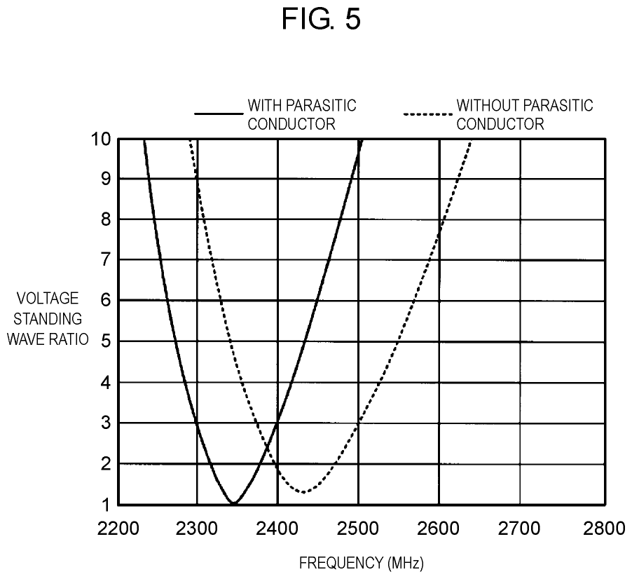

FIG. 5 is a graph showing frequency characteristics of voltage standing wave ratios (VSWRs), where two cases are compared: one is antenna device 100 according to the first exemplary embodiment (the case where parasitic conductor 6 is included), and the other is a comparative example (the case where parasitic conductor 6 is not included). Simulations are conducted under the same conditions except the presence or absence of parasitic conductor 6.

As apparently understood from this graph, the voltage standing wave ratio of antenna device 100 of the present exemplary embodiment including parasitic conductor 6 is shifted to the low frequency side. In particular, when paying attention to the minimum values of the voltage standing wave ratios in the graph, the minimum value for the comparative example (no parasitic conductor) is at 2,430 MHz, but the minimum value for antenna device 100 of the present exemplary embodiment including parasitic conductor 6 is at 2,340 MHz, that is, the low frequency side. As a result, a larger antenna conductor is required for lower frequencies, however, when parasitic conductor 6 is provided, it is possible to achieve antenna device 100 that works appropriately at lower frequencies, without changing the size of the antenna conductor.

### Second Exemplary Embodiment

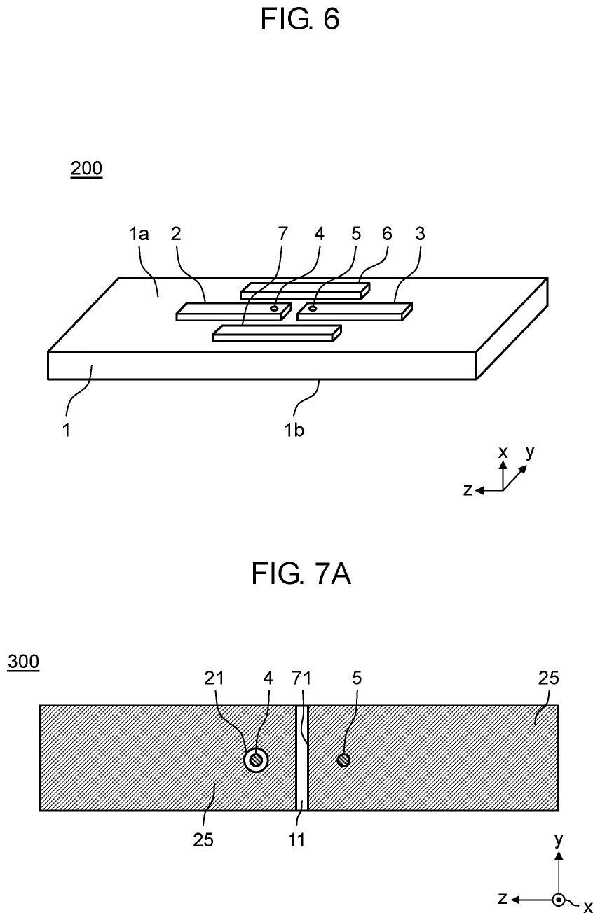

In the following, a configuration of antenna device 200 according to a second exemplary embodiment will be described with reference to FIG. 6.

FIG. 6 is a perspective view showing an outer appearance of antenna device 200 according to the second exemplary embodiment. Antenna device 200 has parasitic conductor 7 in addition to parasitic conductor 6 of the first exemplary embodiment.

In the second exemplary embodiment, similarly to the first exemplary embodiment, parasitic conductors 6, 7 are disposed on printed wiring board 1 to be opposed to AMC 20 and to be adjacent to antenna conductors 2, 3 with a predetermined distance secured between parasitic conductors 6, 7 and antenna conductors 2, 3. In the second exemplary embodiment, parasitic conductors 6, 7 are disposed on both sides (in the y direction) of antenna conductors 2, 3 and in parallel to the z direction in which antenna conductors 2, 3 are disposed. Two parasitic conductors 6, 7 further increase the capacitance, so that the frequency can be further shifted to the lower side.

### Third Exemplary Embodiment

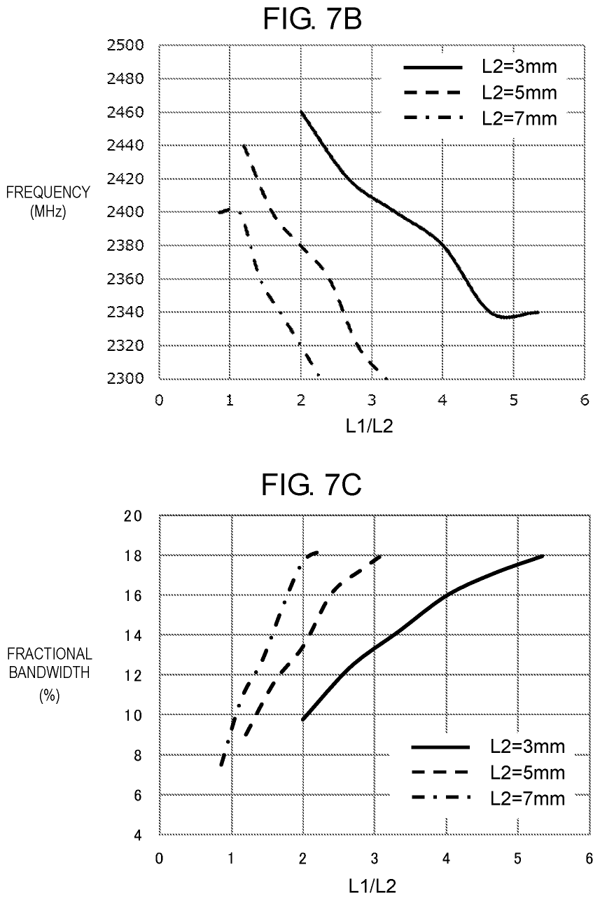

Next, with reference to FIGS. 7A to 7C, a description will be given on characteristics of antenna device 300 according to a third exemplary embodiment when a length L1 of antenna conductor and a length L2 of parasitic conductor 6 are varied. FIG. 7A is an upper surface view of antenna device 300, where layers upper than AMC 25 are deleted. As shown in FIG. 7A, antenna device 300 is different from antenna device 100 described in the first exemplary embodiment, and openings 20a, 20b, 20c, 20d are not formed in AMC 25. The other configuration is the same as the configuration of antenna device 100 and will not be described.

FIG. 7B is a graph showing a frequency at which a voltage standing wave ratio exhibits a minimum with respect to a ratio L1/L2, which is a ratio of the length L1 of the antenna conductor to the length L2 of parasitic conductor 6 of antenna device 300. FIG. 7C is a graph showing a fractional bandwidth of antenna device 300 with respect to a ratio of the length L1 of the antenna conductor to the length L2 of parasitic conductor 6. FIGS. 7B and 7C are each a result of simulations conducted on cases where the length L1 of the antenna conductor is 6 mm, 8 mm, 10 mm, 12 mm, 14 mm, or 16 mm and the length L2 of parasitic conductor 6 is 3 mm, 5 mm, or 7 mm. The fractional bandwidth shown in FIG. 7C represents a ratio of a band of frequencies at which the voltage standing wave ratio is less than or equal to 3 to a frequency at which the voltage standing wave ratio exhibits a minimum.

As shown in FIG. 7B, there is a tendency that, for any length L2 of parasitic conductor 6, the frequency at which the voltage standing wave ratio exhibits a minimum decreases as the length L1 of the antenna conductor increases, and, at the same time, there is a tendency that the frequency at which the voltage standing wave ratio exhibits a minimum decreases as the length L2 of parasitic conductor 6 is longer. For example, when paying attention to the case where the frequency at which the voltage standing wave ratio exhibits a minimum is 2,340 MHz, the length L1 of the antenna conductor needs to be about 14 mm, about 13 mm, and about 11 mm in the case of the length L2 of parasitic conductor 6 is 3 mm, 5 mm, and 7 mm, respectively, which fact means that the length L1 of the antenna conductor can be reduced by increasing the length L2 of parasitic conductor 6, whereby a shorter antenna device 100 can be achieved.

Further, as shown in FIG. 7C, there is a tendency that the fractional bandwidth increases for any length L2 of parasitic conductor 6 as the length L1 of the antenna conductor increases, and, at the same time, there is a tendency that the fractional bandwidth is larger as the length L2 of parasitic conductor 6 is longer. The fact that the fractional bandwidth is large means that radio waves in a relatively wide frequency range can be received, and means that the effect to reduce manufacturing variation of antenna devices and to reduce fluctuation in characteristics depending on installation position is large.

As described above, by providing larger parasitic conductor 6, an antenna conductor can be made accordingly smaller, whereby antenna device 100 can be made smaller, and, at the same time, it is possible to achieve antenna device 100 capable of stably receiving radio waves.

### Advantageous Effect and the Like

Each of the antenna devices of the first to third exemplary embodiments includes substrate 1 having an artificial magnetic conductor (AMC), antenna conductors 2, 3, disposed on substrate 1, and a parasitic conductor disposed to be apart from antenna conductors 2,3.

With this arrangement, since the parasitic conductor is provided on the same plane as antenna conductors 2, 3, capacitive coupling between antenna conductors 2, 3 and the artificial magnetic conductor is enhanced, and a capacitance is increased, whereby the frequency can be shifted to a low frequency band side. Further, the antenna device can work appropriately at frequencies on the lower frequency band side without increasing the length of antenna conductors 2, 3, so that the antenna device can be miniaturized.

In each of the antenna devices according to the first to third exemplary embodiments, antenna conductors 2, 3 and the parasitic conductor or parasitic conductors are disposed adjacent to each other on substrate 1. This arrangement enables antenna conductors 2, 3 and the parasitic conductor to be easily positioned and manufactured.

Further, antenna device 200 of the second exemplary embodiment has at least two parasitic conductors 6, 7 disposed on both sides of antenna conductors 2, 3. This arrangement easily enhances the capacitive coupling.

Further, in a case where the parasitic conductor is on the top layer of the antenna device as in the first to third exemplary embodiments, the frequency can be easily adjusted by modifying the parasitic conductor. Therefore, manufacturing of an antenna device with the frequency being adjusted, for example, manufacturing of various types of antenna devices is easy.

### First Modified Example

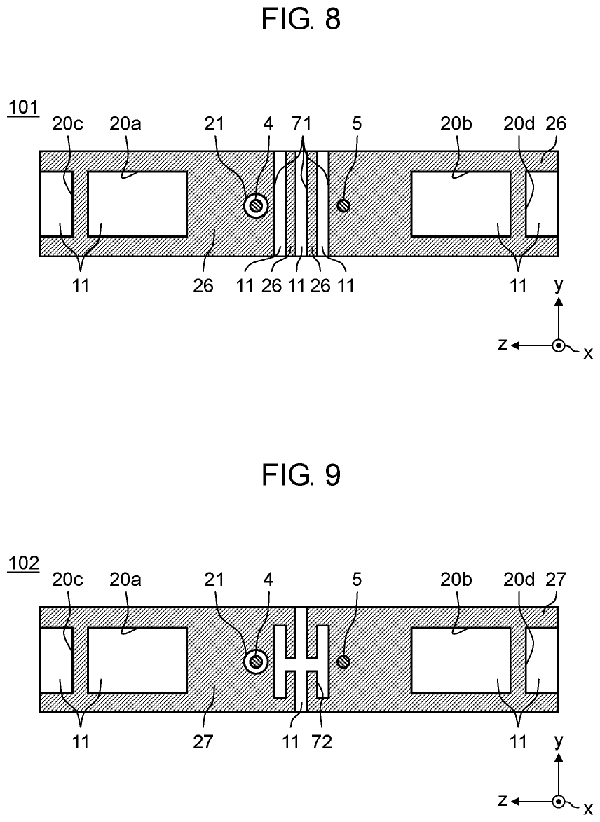

FIG. 8 is an upper surface view of antenna device 101 according to a first modified example, where layers upper than AMC 26 are deleted. Antenna device 101 according to the first modified example has three slits 71 in the layer of AMC 26 as shown in FIG. 8, and on this point, antenna device 101 is different from antenna device 100 of the first exemplary embodiment, which has one slit 71 in the layer of AMC 20, but the other configuration of antenna device 101 is the same as the configuration of antenna device 100.

Antenna device 101 according to the first modified example provides a similar action and effect to antenna device 100 according to the first exemplary embodiment. Note that also in the antenna devices described in the second and third exemplary embodiments, it is possible to employ the layer of AMC 26 of the first modified example.

### Second Modified Example

FIG. 9 is an upper surface view of antenna device 102 according to a second modified example, where layers upper than AMC 27 are deleted. Antenna device 102 according to the second modified example has slit 72 in the layer of AMC 27 as shown in FIG. 9, and on this point, antenna device 102 is different from antenna device 100 of the first exemplary embodiment, which has slit 71 in the layer of AMC 20, but the other configuration of antenna device 102 is the same as the configuration of antenna device 101. As shown in FIG. 9, slit 72 has a slit part having the same shape as one slit 71 shown in FIG. 3 and has, on the both sides of the slit part, slit parts extending a predetermined length in a width direction but not reaching both ends, and these slit parts are connected to each other at a central part in the width direction.

Antenna device 102 according to the second modified example provides a similar action and effect to antenna device 100 according to the first exemplary embodiment. Note that also in the antenna devices described in the second and third exemplary embodiments, it is possible to employ the layer of AMC 27 of the second modified example.

### Third Modified Example

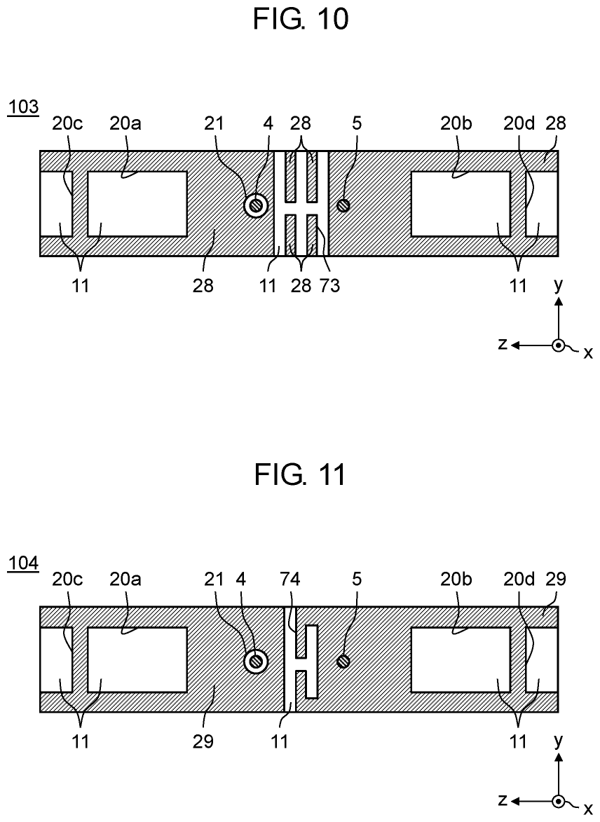

FIG. 10 is an upper surface view of antenna device 103 according to a third modified example, where layers upper than AMC 28 are deleted. Antenna device 103 according to the third modified example has slit 73 in the layer of AMC 28, and on this point, antenna device 103 is different from antenna device 100 of the first exemplary embodiment, which has slit 71 in the layer of AMC 20, but the other configuration of antenna device 103 is the same as the configuration of antenna device 100. As shown in FIG. 10, slit 73 has a shape in which three slits 71 shown in FIG. 8 are connected to each other at the central part in the width direction.

Antenna device 103 according to the third modified example provides a similar action and effect to antenna device 100 according to the first exemplary embodiment. Note that also in the antenna devices described in the second and third exemplary embodiments, it is possible to employ the layer of AMC 28 of the third modified example.

### Fourth Modified Example

FIG. 11 is an upper surface view of antenna device 104 according to a fourth modified example, where layers upper than AMC 29 are deleted. Antenna device 104 according to the fourth modified example has slit 74 in the layer of AMC 29, and on this point, antenna device 104 is different from antenna device 100 of the first exemplary embodiment, which has slit 71 in the layer of AMC 20, but the other configuration of antenna device 104 is the same as the configuration of antenna device 100. As shown in FIG. 11, slit 74 has a shape in which one slit 71 shown in FIG. 3 and a slit extending a predetermined length in a width direction but not reaching both end in the width direction are connected to each other at a central part in the width direction.

Antenna device 104 according to the fourth modified example provides a similar action and effect to antenna device 100 according to the first exemplary embodiment. Note that also in the antenna devices described in the second and third exemplary embodiments, it is possible to employ the layer of AMC 29 of the fourth modified example.

### Other Exemplary Embodiments

In the above, as an example of techniques disclosed in the present application, a description has been given taking a dipole antenna as an example in the above exemplary embodiments and modified examples. However, other antennas such as a monopole antenna, an inverted-L antenna, and an inverted-F antenna may be used. For example, it is possible to configure a monopole antenna by including only one antenna conductor 2 instead of two antenna conductors 2, 3 of antenna device 100 according to the first exemplary embodiment of FIG. 1. In this case, a similar action and effect is provided except that a radiation characteristic is different from antenna device 100. Note that a monopole antenna may be used for the antenna devices described in the second and third exemplary embodiments and the first to fourth modified examples.

In the above exemplary embodiments and modified examples, antenna devices for the 2.4 GHz band have been described, but the present disclosure may be applied to antenna devices for other frequency bands.

In the above exemplary embodiments and modified examples, printed wiring board 1, which is a laminated substrate, is used to configure an antenna device. However, the antenna device only needs to be configured in such a manner that antenna conductors 2, 3, an AMC, and a ground conductor are stacked in order and to be a predetermined distance apart from each other. For example, a part or a whole of each dielectric substrate 10, 11 may be an air layer. Further, each of the antenna devices according to the above exemplary embodiments and modified examples includes one ground conductor 30, but may include a plurality of ground conductors.

Further, the ground conductor and the AMC may be provided to be opposed to each other, and in addition, may be provided such that, in a plan view, the ground conductor is included in the AMC, or the AMC is included in the ground conductor. This configuration miniaturizes the antenna device in size.

In each case described in the exemplary embodiments and modified examples, one to three slits are formed in the AMC; however, four or more slits may be formed, or all or some of the plurality of slits may be connected to each other.

Exemplary embodiments of an antenna device according to the present disclosure have been described above with reference to the drawings, but the present discloser is not limited to those examples. It is apparent that those skilled in the art can conceive various modification examples, substitution examples, addition examples, removal examples, equivalent examples, and the like within the scope described in the attached claims, and those examples are of course understood to be within the technical scope of the present disclosure.

### INDUSTRIAL APPLICABILITY

An antenna device of the present disclosure is useful in the field where an antenna device is required to work appropriately at frequencies on the lower frequency band side without increasing the length of the antenna conductor.

### REFERENCE MARKS IN THE DRAWINGS

1: substrate (printed wiring board)
2, 3: antenna conductor
4, 5: via conductor
6, 7: parasitic conductor
10, 11: dielectric substrate
20, 25, 26, 27, 28, 29: artificial magnetic conductor (AMC)
20a, 20b, 20c, 20d: opening
21, 31: via conductor insulating hole
30: ground conductor
71, 72, 73, 74: slit
100, 101, 102, 103, 104, 200, 300: antenna device
Q1, Q2: feeding point

1. An antenna device comprising:
a substrate having an artificial magnetic conductor;
a plurality of antenna conductors disposed on the substrate; and
a parasitic conductor disposed on the substrate, the parasitic conductor being apart from and adjacent to the plurality of antenna conductors.

2. The antenna device according to claim 1, wherein the plurality of antenna conductors and the parasitic conductor are disposed adjacent to each other on the substrate.

3. The antenna device according to claim 1, wherein
the substrate has a dielectric substrate, and
the plurality of antenna conductors and the parasitic conductor are opposed to the artificial magnetic conductor via the dielectric substrate.

4. The antenna device according to claim 3, wherein the artificial magnetic conductor has an opening.

5. The antenna device according to claim 1, wherein
the parasitic conductor includes a first parasitic conductor and a second parasitic conductor, and
the first parasitic conductor and the second parasitic conductor are disposed such that the plurality of antenna conductors are between the first parasitic conductor and the second parasitic conductor.

6. The antenna device according to claim 1, wherein
the plurality of antenna conductors include a feeding antenna and a grounded antenna, and
the plurality of antenna conductors are disposed such that a feeding-side end of the feeding antenna and a feeding-side end of the grounded antenna are opposed to each other.
